(19) United States
(12) Patent Application Publication
(10) Pub. No.: US 2021/0118016 A1
(43) Pub. Date: Apr. 22, 2021

(54) NET VALUATION GUARANTEE FOR VEHICLES

(71) Applicant: Carma Automotive Inc., Regina (CA)

(72) Inventors: Sadra Abedinzadeh, Regina (CA); Dan Broderick, Regina (CA); Bruce Axelson, Regina (CA); Cam Bottrell, Regina (CA); Philip James Morris, Regina (CA)

(21) Appl. No.: 16/906,642

(22) Filed: Jun. 19, 2020

(30) Foreign Application Priority Data
Oct. 16, 2019 (CA) 3058868

(51) Int. Cl. G06Q 30/02; G06Q 30/06; G06F 16/9035; G06F 16/9038

(52) U.S. Cl. CPC G06Q 30/0278; G06Q 30/0206; G06F 16/9038; G06F 16/9035; G06Q 30/0611

(57) ABSTRACT

A method of generating and honoring a time-limited net valuation guarantee for used target vehicles in purchase and trade-in transactions. A user would submit a captured parameter set of details related to at least one target vehicle to a pricing software component. The captured parameter set would be used to identify a gross value for the target vehicle as well as to generate an estimated reconditioning cost. The net valuation of the target vehicle, being the gross value less the estimated reconditioning cost, would be stored along with a calculated expiry date in a valuation record. Subsequent and before the calculated expiry date, the owner of the target vehicle could redeem the guarantee at a subscribing vehicle acquisition outlet and the subscribing vehicle acquisition outlet would honor the net valuation stored within the record.

### FIELD OF THE INVENTION

This invention is in the field of automated business systems for use in the automobile and equipment sales industry, and more specifically provides a system and method for the generation and issuance of a time-limited net valuation guarantee in respect of a vehicle or similar piece of equipment, which valuation can be honored for a fixed period of time and is generated without the need for subjective vehicle inspection.

### BACKGROUND

Businesses in many industries have seen their business workflows enhanced over the last number of years by the increased availability of various software tools to assist in business decision-making, business processes and sales techniques. This is included various types of software tools available in the automotive industry and particularly for automotive dealerships, vehicle sales representation and companies. Different software tools are available to allow for the automated processing of paperwork, inventory handling, as well as for lead generation and sales prospecting.

One of the key business processes involved in automotive dealerships is the trade-in and handling of used vehicles. Quite often in a dealership that sells new vehicles, used vehicles are taken in on trade and in other environments used vehicle specialist dealerships may also simply purchase used vehicles from people wishing to sell them. Handling and valuation of used vehicle inventory is a narrow margin element of the business which requires high accuracy.

One of the key calculations that needs to be made in the acceptance and processing of used vehicle inventory, either for purchase or as trade-ins, is the estimation of the value of used car or vehicle. There are many different types of value guides available, both printed and online, however none of them accurately account for the cost of reconditioning the vehicle in the dealership to whatever the predetermined reconditioning standard is for resale. Reconditioning cost is the cost of the process of repairs i.e. mechanical, cosmetic repairs, replacement of tires and glass or the like—needed to be made to the vehicle in order to sell it again. The reconditioning cost or difference can be a make or break cost element for dealerships, in this typically low gross margin business. Traditionally the estimation of used vehicle value and reconditioning cost would be done manually and subjectively by staff in a dealership who would inspect the vehicle and based on past experience and whatever documentation was prepared at the dealership level be able to come up with a reasonably accurate reconditioning cost and used vehicle value. This is extremely time intensive and takes staff of a large amount of past experience and dealership history to deliver in a reasonable fashion.

In certain basic software iterations of the dealership level tools have been used which solve the problem of estimating the value of a used vehicle by offering static values. For example, each particular type of a repair might be worth a static amount—a new windshield is $500, new tires are $400, or the like—while this is better than a completely manual process it cannot be used in an environment where the vehicle is not seen and inspected by the dealership since in order for this type of a method to work each type of a statically valued repair needs to be assessed and inventoried by the dealership on viewing the vehicle. This method requires extra information i.e. you already need to know what is wrong with the vehicle in order to come up with the value for a used vehicle based on reconditioning cost. Some tools have also been developed which simply allow for the estimation of reconditioning cost based upon the mileage of the vehicle but this again is not particular or necessarily accurate.

Beyond the resource requirements of manual inspection and valuation of used vehicles, one of the other significant limitations in the use vehicle inventory business which is impacted by this historical valuation method is the ability to use advanced electronic or online lead generation tools. Dealerships interested in purchasing or accepting trade-ins of used vehicle inventory have historically not been able to provide sight unseen electronic valuations or confirmations of the value they will extend on a vehicle for purchase or trade-in. This typically requires production of the vehicle for evaluation to be made. If it were possible to provide a means of electronic valuation of a vehicle on a sight unseen basis, many different types of new dealership marketing tools and vehicle marketing opportunities could be conceived which could incorporate a sight unseen electronic valuation step—i.e. it would be possible to provide the ability to conduct many types of online lead generation and sales solicitation methods and techniques if it were possible to value a vehicle without a personal inspection.

One of the other limitations to valuation of used vehicles for acceptance into a purchase or trade-in inventory is that of valuation is typically only contemporaneously useful. That is to say, the valuation is typically only good for a fixed period of time, since the age of the vehicle continues to increase, wear and tear increases, as the vehicle continues to be used after evaluation takes place. As such, in typical historical methods where personal inspections have been undertaken of vehicles, valuation offers which are made to customers typically are only applicable or effective at the time they are given her for a very short time thereafter. If the customer potentially does not exercise the trade-in on the basis of the value assessed by a personal inspection, in historical methods, at the time the valuation is made, but rather waits several weeks even to come back and seek to conduct a trade-in of their vehicle, the valuation is likely no longer of force and effect and needs to be redone. If it were possible to create an electronic vehicle valuation method that would allow for evaluation of vehicles that would permit a reasonable period of effect for a valuation calculation this would be extremely desirable and commercially effective—i.e. if it were possible to come up with a valuation for a vehicle in an unattended and uninspected method that factored in a certain length of time for effectiveness, it is believed that this would be commercially accepted and of extreme value to modernize certain online business sales techniques in the vehicle and other similar industries since it would allow for companies to solicit a vehicle trade-in on a new vehicle purchase or the like, for example, based on trade-in value which is calculated and extended for a fixed period of time to the customer.

Overall then it is believed that if it were possible to create a means and method of rendering of a vehicle valuation without the need for personal inspection using an online tool which accounted for an estimation of vehicle reconditioning costs, by relying primarily or completely upon objective parameters of particular vehicles being mathematically modeled to allow for the most accurate possible estimation of reconditioning cost based on historical transaction costs, and would allow for the issuance of a guaranteed vehicle valuation for trade-in or sale purposes that was issued and effective for a fixed period of time, this would be an extremely desirable commercial result in a heretofore largely nonautomated area of the automotive distribution and resale industry.

### SUMMARY OF THE INVENTION:

As outlined above, the object of the present invention is to provide a computer implemented method of issuing a time-limited net valuation guarantee for a target vehicle, which could effectively be used by the vehicle as a guarantee of a sale or trade-in value for a vehicle within a limited time. The net valuation of the vehicle would incorporate market value and anticipated reconditioning cost, and would permit for the issuance of valuations without a personal inspection being conducted of the vehicle.

In a first embodiment of the invention, these objectives are achieved in a computer implemented method of issuing a time-limited net valuation guarantee for a target vehicle, executed comprising a first step are using equipment comprising a server with a processor and memory, a network interface for communication with client devices, and a pricing software component capable of carrying out the steps in the method in conjunction with a valuation database.

The valuation database comprises a plurality of valuation records. Each valuation record corresponds to a net valuation of a target vehicle conducted in accordance with the method, and includes at least identifying information of the target vehicle—such as a vehicle serial number, owner details or the like—along with parameter values of at least one vehicle parameter in respect of the target vehicle, the calculated net valuation, and an expiry date for the net valuation contained in the valuation record. As will be understood from this document on the scope outlined elsewhere herein, any type of a vehicle parameter capable of being captured of value is contemplated within the scope of the present invention including something as simple as vehicle make, age, model, mileage or the like through to more detailed or granular parameters.

The server would also, via the network interface or otherwise, comprise an operative connection to a market data source which comprises a plurality of market records each indicating parameter values of at least one vehicle parameter of a vehicle and a gross value for the vehicle having such a parameter. Effectively, the market data source would permit the capture of gross value for a target vehicle having a particular combination of parameters captured and stored for the purpose of the generation of valuation record. The system and method of the present invention could operate based on varying numbers of parameters being captured in respect to particular target vehicles and any such modifications or flexibility in the method will be understood to be within the scope of the present invention.

From a high level, the valuation of a target vehicle consists of capturing parameters of the vehicle from a user via the user interface of a client device in communication with the server, establishing a gross value for the vehicle from the market data source, and then using the pricing software component to execute a reconditioning cost calculation and docking the cost of reconditioning from the gross value to render a net vehicle valuation which is stored.

In further detail, the method comprises for each valuation of at least one target vehicle the execution of a valuation session. The valuation session comprises the following series of method substeps executed by the server in conjunction with devices or software in network communication with the server, the valuation database and the pricing software component. The first element of the valuation session would comprise receiving valuation input data at the server from a client device in network communication with the server in respect of each of the at least one target vehicle. Evaluation session could conduct evaluations of one or more vehicles at the same time and both such approaches are contemplated within the scope of the present invention. The valuation input data received at the server would comprise at least identifying information of the vehicle, such as a serial number, owner details of the like, and a captured parameter set being parameter values of at least one vehicle parameter of each of the at least one target vehicles. As outlined above and throughout this document, it is explicitly contemplated that in many cases it would be more desirable to capture more than one parameter value in respect of a target vehicle to provide a more granular or accurate valuation, but the minimum number of parameter values for a target vehicle which could be used will be understood to be variable and all such approaches are contemplated within the scope of the present invention. The parameter values entered in respect of a target vehicle need to correspond to an available gross value for the target vehicle in the market data source.

On receipt of the valuation input data at the server in respect of a target vehicle, being the subject vehicle, the pricing software component on the server will establish the net valuation of the subject vehicle by determining a gross value for the subject vehicle to the market data source.

As outlined above the market data source will contain a plurality of gross value records, each corresponding to a particular combination of vehicle parameters of target vehicles—vehicle make, age, mileage etc.—the gross value of the subject vehicle will be determined by selecting a gross value corresponding to the particular combination of parameter values in the captured parameter set for the particular subject vehicle, received from the client device by the server. More than one market data source might be used in certain embodiments of the present invention if it was desired to for example take more than one value and average them or select a favorable one. Many different types of averaging a normalization of gross value data available from one or more sources will be understood to be within the scope of the present invention without departing from the intention outlined in the claims of this document.

The pricing software component will next use the captured parameter set of the subject vehicle and apply a mathematical reconditioning cost function to that parameter set to yield the estimated reconditioning cost of the subject vehicle. The system might contain more than one mathematical reconditioning cost function dependent upon the specific subscribing vehicle acquisition outlet to whom it maybe desired to trade-in or sell the vehicle in question—certain used vehicle outlets may require a slightly different reconditioning cost calculation to be applied and one or more reconditioning cost functions could be applied to the captured parameter set of a particular subject vehicle to render a most accurate estimated reconditioning cost for the subject vehicle depending upon where the subject vehicle will be traded in or sold. The final step in the calculation of the net valuation of the subject vehicle is subtracting the estimated reconditioning cost rendered by the mathematical reconditioning cost function from the gross value of the subject vehicle selected from the market data source. The result of these calculations is the net valuation of the subject vehicle which it is desired pursuant to method of the present invention to guarantee for the trade-in and sale of the vehicle for a limited time.

Following the finalization of the calculation of the net valuation of each subject vehicle, an expiry date for the net valuation would be calculated, based upon the date of the valuation session or other parameters. The expiry date calculation in a simple approach might be as simple as adding a predetermined number of days within which it is desired to guarantee the net valuation amount for the vehicle, or a more elaborate approach could be taken based upon even contents of the captured parameter set of the subject vehicle. The expiry date as calculated could also vary dependent upon the intended trade-in or sale outlet for the vehicle in respect of which a valuation is generated. For example, certain used vehicle outlets might be prepared to guarantee evaluation for two weeks, where others might be prepared to guarantee the valuation for a month. The system could be adjusted to adaptively render the appropriate expiry date or dates for storage in a valuation record in respect of a particular valuation of the subject vehicle.

The pricing software component would create a valuation record in the valuation database corresponding to the subject vehicle, which contained the calculated net valuation, the calculated expiry date, as well as the identifying information of the subject vehicle and any captured parameter set in respect of the vehicle, so that the valuation could later be regenerated or checked, and for other record-keeping purposes, as well as for the primary purpose of the method of the present invention which would be that within the timeframe defined by the calculated expiry date and owner of the subject vehicle could present that vehicle at a subscribing resale or trade-in outlet and, subject to cursory review or verification upon personal inspection of the vehicle, receive the guaranteed trade-in or sale value in a commercial transaction as originally calculated by the pricing software component. From a very practical and commercial perspective what this will allow is for automotive dealerships to provide online presale support to customers in which they can provide guaranteed valuations of trade-in vehicles while customers are searching and shopping online for new vehicles.

On presentation of the target vehicle to a subscribing vehicle acquisition outlet, along with the details of a corresponding valuation record for example the vehicle identifying information or other information which could be used to look up or verify the valuation originally provided by the system and method of the present invention, the subscribing vehicle acquisition outlet will honor the calculated net valuation for the target vehicle so long as the expiry date of the valuation record as calculated and stored has not expired.

A subscribing vehicle acquisition outlet might be a vehicle accepting the target vehicle for purchase from the owner for the value of the calculated net valuation stored within the valuation record corresponding thereto, or in other circumstances might be accepting the target vehicle is a trade-in in a purchase transaction for another vehicle and will provide a trade-in valuation in the transaction equivalent to the calculated net valuation stored within the valuation record. It will be understood that in certain embodiments of the method of the present invention, the pricing software component could also generate two net valuations for a particular subject vehicle if there were different mathematics applicable to the generation of a purchase price versus a trade-in price. This type of a modification or enhancement of the system and method of the present invention will be understood to be within the scope of the method as well.

The method of the present invention could either be used by an individual owner of a target vehicle to secure a valuation for their vehicle in anticipation of a sale or trade-in transaction, or in other circumstances the method of the present invention could actually be used by the subscribing vehicle acquisition outlet to quickly generate valuations for vehicles as well. In the case of an automotive dealer or other subscribing vehicle acquisition outlet being the originating terminal on the network and communication with the server providing or initiating the valuation session details the subscribing vehicle acquisition outlet might use a human interface to enter the details for one or more target vehicles to be valued in a valuation session, or in other cases, a local server of the subscribing Outlook could be a network communication with the server of the present invention and could automatically transmit groups of information to initiate valuation sessions for more than one target vehicle. Where the client device and network communication with the server and evaluation session is a server of a subscribing vehicle acquisition outlet, the valuation input data for at least one target vehicle could be assembled for transmission to the server from accessible data sources of the subscribing vehicle acquisition outlet. All such approaches to the use of the automated valuation method of the present invention are contemplated and will be understood to be within the scope of the present invention.

Just like the method of the present invention can be initiated for multiple types of client devices in communication with the server, the server could also transmit the results of valuations of subject vehicles to one or more types of remote client devices, again being either the client device of an owner or unidentified third party related to the vehicle, or a server or local computer at the premises of a subscribing vehicle acquisition outlet. Again all of these different approaches are contemplated within the scope of the present invention.

The gross value of a vehicle which is identified from the market data source and used to calculate the net valuation of the subject vehicle could be a fixed value rendered by the query of the market data source, or in other embodiments, the gross value determined from the market data source might be a range with a number value and a lower value. In the case of a fixed value gross value of the subject vehicle, the net valuation calculated could also be a fixed value or range depending on the nature of the result rendered by the mathematical reconditioning cost function. In the case of the gross valuation of the vehicle obtained from the market data source being arranged with an upper and lower value, the net valuation calculation could also be arranged with an upper and lower value based upon the upper and lower value of the gross value range, or in certain cases if the mathematical reconditioning cost function renders a range output rather than a fixed number the upper and lower values of the gross value range could be modified by the reconditioning cost range to yield a net valuation calculation which is a range with a modified upper and lower value. Both fixed value and range value results and inputs to the method of the present invention are contemplated within the scope hereof.

Many different types of mathematical reconditioning cost functions will be understood to those skilled in the art of statistical analysis and mathematics of this nature. In some cases the mathematical reconditioning cost function might be a mathematical model which could render estimated reconditioning cost for a subject vehicle based upon historical reconditioning transactions for reconditioning vehicles corresponding to the captured parameter set. It is explicitly contemplated that a mathematical model of this nature which would incorporate artificial intelligence and reliance upon large historical data set to render the most accurate estimated reconditioning costs for subject vehicles would be the ideal or most desirable approach to be taken in the rendering of estimated reconditioning costs, to maximize the efficiency, and the profitability, the method of the present invention to the subscribing vehicle acquisition outlet.

However, there will also be understood to be many other different types of more basic software approaches which could be taken to identify estimated reconditioning costs based upon the contents of the captured parameter set in respect of a vehicle. All such approaches are contemplated within the scope of the present invention.

In terms of the specific types of reconditioning cost functions, mathematical functions which could be applied to a parameter set to yield a result, which could be used, might comprise one or more of the following types of mathematical functions:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

It will be understood that the reconditioning cost functions which could be established and maintained by the software and method of the present invention could comprise any number of the above types of algorithms or mathematical functions, or others which have not been listed which will also be understood by those skilled in the art to be effective for the purpose of the execution of the method otherwise outlined herein.

It will also be understood that any number of different types of vehicle parameters could be captured in respect of a target vehicle for use in a valuation session in accordance with the method of the present invention. It is specifically contemplated that the at least one vehicle parameter could be selected from the following group:
a. vehicle type;
b. vehicle manufacturer;
c. vehicle model;
d. vehicle model year;
e. vehicle odometer reading;
f. vehicle configuration options;
g. vehicle trim options; and
h. vehicle identification number (VIN);

to name a few. Any number and type of different vehicle parameters which would be used in the collation or generation of gross market values for target vehicles, or in a mathematical reconditioning cost calculation function, will all be understood to be within the scope of the present invention.

In certain cases, for example based on geographic location, variance in the reconditioning standard, or other specific or customer related circumstances, a reconditioning cost function established for use in the remainder of the method of the present invention would accommodate the application of at least one cost modifier to the estimated reconditioning cost of a target vehicle. Effectively, it is contemplated that the cost modifiers could be mathematically or formulaically applied modifiers to the estimated reconditioning cost rendered by the reconditioning cost function. For example, if it was desired by a particular dealer or reconditioning outlet to modify the costs rendered by a reconditioning cost function by fixed percentage to accommodate some difference in their approach to resale, reconditioning or the like, or any number of other different types of cost modifiers could be contemplated for application. The types of cost modifiers which could be used could be selected non-exclusively from the list of user specific cost modifiers, geographic cost modifiers, subtotal labour costs, subtotal parts cost, estimated market value of the vehicle before reconditioning was started, accident and repair history modifiers, and average labour cost at the time or location of reconditioning to be conducted. Again, based on this nonexhaustive list of the types of cost modifiers which are contemplated to be used it will be understood the intention here that in the rendering of a estimated vehicle reconditioning cost in respect of a particular reconditioning outlet, it may be desired to apply mathematical modifications to those results outside of the result or the mathematical reconditioning cost function and any such type of modification is contemplated within the scope of the concept of cost modifiers and encompassed within the present invention.

Following the creation of a valuation record in the valuation database, the valuation session would be completed by transmission of the details of the valuation record for client device of the user in respect of each subject vehicle. The transmission of the details of the valuation record could comprise the display of the details of the valuation record on the screen or human interface of a user client device, or could be transmitted by email or other electronic transmission to a client device either for visible or human use, or for storage and incorporation into a local computer system by a user or a subscribing vehicle acquisition outlet.

In a further embodiment of the present invention, there is provided the necessary modifications to the software on the server of the present invention to enable a user interface of a subscriber outlet device for use in the redemption of the calculated net valuation of a target vehicle. A user interface of a subscriber outlet device could permit the data entry of vehicle identifying information, or a record identifier of a particular valuation record in the database, and upon the entry of such information and transmission of same to the server, database lookup to identify the corresponding valuation record in the valuation database would be conducted and the details of that valuation record transmitted back to the originating subscriber outlet device.

The method of the present invention could be conducted where the number of subscribing vehicle acquisition outlets is one i.e. a single subscribing acquisition outlet or automotive dealership could use the system and method of the present invention to provide a presale or qualification mechanism via website or other remote computer interface to users to allow them to secure advance guaranteed net valuations for target vehicles, or in other cases the service and the method of the present invention might be delivered in a service bureau method wherein the number of subscribing vehicle acquisition outlets is more than one. I.e. more than one subscribing vehicle acquisition outlet might participate in the method and be prepared to redeem vehicles based upon the net valuations rendered by the software and method of the present invention. The net valuations rendered by the method, in a service bureau method where the number of subscribing vehicle acquisition outlets is more than one, might be the same for every subscribing vehicle acquisition outlet, or the software of the present invention in calculation of the net valuation for a particular valuation record might either through the mathematical reconditioning cost function or otherwise apply outlet specific modifications to the calculated net valuations. All such approaches in the context of more than one subscribing vehicle acquisition outlet are contemplated within the scope of the present invention.

Where the method of the present invention was offered in a service bureau format it could either be offered on the basis that the subscribing vehicle acquisition outlet would honor net valuations issued in accordance with the method, or in another contemplated embodiment, the system of the present invention could on a freestanding basis, unaffiliated with any particular explicit subscribing vehicle acquisition outlets, issue net valuations which would be redeemable at any one of a network of subscribing vehicle acquisition outlets. All such approaches and modifications to achieve this are contemplated within the scope of the present invention.

In certain embodiments of the method of the present invention, subscribing vehicle acquisition outlets might be notified in a vehicle acquisition outlet notification step, upon the generation of a valuation record. For example, based upon vehicle identifying information, user identifying information, IP address information of the originating device or otherwise, a geo-fence method might be used to identify relevant subscribing vehicle acquisition outlets in relation to a particular target vehicle, and a notification could be provided to those identified relevant subscribing vehicle acquisition outlets to allow them to make a marketing approach to the customer and make a specific offer for trading or sale etc. The addition of the vehicle acquisition outlet notification step will be understood to be within the scope of the present invention in many different embodiments and all are contemplated within the scope hereof.

### DESCRIPTION OF THE DRAWINGS:

While the invention is claimed in the concluding portions, preferred embodiments are provided in the detailed description which may be best understood with the diagrams where like parts in each of the several diagrams are labeled with like numerals, and where:

FIG. 1 is a block diagram showing the components of one embodiment of a system which could be used in the method of the present invention;

FIG. 2 is a block diagram showing the components of one embodiment of the server of FIG. 1;

FIG. 3 is a diagram showing a sample of a data structure of the valuation database of the embodiment of FIG. 1;

FIG. 4 is a flowchart demonstrating the steps of one embodiment of a method of creation of a parameter based reconditioning index in accordance with the present invention;

FIG. 5 is a flowchart demonstrating the steps of one embodiment of a method of updating the index created in accordance with the method of FIG. 4;

FIG. 6 is a chart that demonstrates a sample of a reconditioning cost function; and

FIG. 7 is an exemplary graphical user interface of the invention disclosed herein.

### DETAILED DESCRIPTION OF ILLUSTRATED EMBODIMENTS:

As outlined above, the present invention pertains to the creation of a parameter based reconditioning index for use in the estimation of the reconditioning cost of target vehicles to a defined standard based upon historical reconditioning data and the use of that index in the estimation of reconditioning cost and vehicle trade-in values. The following provides further detail of the intended scope and some demonstrative embodiments of the present invention.

Vehicle Parameters:

One of the key condition parameters of a vehicle which could be used to provide the ability to generally estimate reconditioning cost has often in the past been the mileage of the vehicle. The mileage of the vehicle is a demonstrative vehicle parameter. The method of the present invention would explicitly rely upon the capture of one or more vehicle parameters with respect to the target vehicle for which a reconditioning cost or trade-in value with the desired to be calculated. Many different types of vehicle parameters are contemplated all of which could be “objective” from the perspective that they could be captured quantitatively or without the need for a physical inspection of the vehicle. As outlined in greater detail throughout, the vehicle parameters which could be used to select mathematical models or relevant historical data from the perspective of assessing reconditioning cost could be selected from the following group:
a. vehicle type;
b. vehicle manufacturer;
c. vehicle model;
d. vehicle model year;
e. vehicle odometer reading;
f. vehicle configuration options;
g. vehicle trim options; or
h. vehicle identification number (VIN).

Any of these types of parameters outlined above or others which might be obvious to those skilled in the art will be understood to be relevant from the perspective of ascertaining the gross market value and the type and cost associated with reconditioning of a particular target vehicle.

Captured Parameter Sets:

The vehicle parameters captured by a user or a customer with respect to a particular target vehicle, and based upon which the reconditioning cost is to be assessed, are captured parameters. The captured parameters which are captured in respect of a particular target vehicle make up a captured parameter set. For example, if a customer were to enter the manufacturer, model, and odometer as three captured parameters through a human client interface and seek the establishment of the net valuation of that vehicle, the captured parameter set is made up of the three parameters being the manufacturer, model and odometer reading.

Market Data Source and Gross Valuation Data:

The method of the present invention revolves around establishing a net valuation for a target vehicle which could be provided as a trade-in value or sale value for a used vehicle by dealership or subscribing vehicle acquisition outlet. The basic calculation for the net valuation of the target vehicle is to take the gross valuation of the vehicle in the market and subtract the estimated reconditioning cost. The gross valuation in the market is a standard valuation for a vehicle at a typical reconditioned standard, and the amount that would be permitted by dealership as a trade-in value or a purchase value for that target vehicle in a transaction with the owner of the vehicle. Whatever the gross valuation of the vehicle for trade-in or purchase purposes at the desired standard is, the estimated reconditioning cost to get the vehicle to that standard would be subtracted. Thus the use of the gross valuation of the vehicle and the estimated reconditioning cost being the two primary variables calculated and used in the remainder of the method, with the estimated reconditioning cost being calculated without a physical inspection of the vehicle by the dealership or outlet.

It is specifically contemplated that a gross valuation dataset would exist in a market data source such as a service bureau or even a database or data set contained within the remainder of the system of the present invention, in which particular combinations of vehicle parameters would correspond to particular gross valuation numbers. For example a particular set of four parameters in respect of a particular target vehicle, being the vehicle manufacturer, vehicle type, the model year and mileage could correspond to a particular typical gross valuation that would be provided for a vehicle at a particular state of reconditioning or repair. Other combinations of parameters could also be stored within the market data source which would again be allowed to permit for a more granular estimation of the gross valuation of a particular target vehicle based upon the number or degree of granularity in the number of vehicle parameters and values captured for use in the method. The market data source would contain gross valuation figures which could be used for every type of vehicle which it was desired to value in accordance with the method of the present invention. Certain target vehicle parameters captured might only be useful in the actual estimation of reconditioning cost versus the selection of a gross valuation amount, but it will be understood that for a particular target vehicle to have a net valuation created in respect of the method of the present invention a gross valuation must be present within the market data source, based on at least some of the vehicle parameters in the captured parameter set or identifying information of the vehicle.

Reconditioning Cost:

As outlined in further detail above, the reconditioning cost of the vehicle is a key determining factor in estimating the amount of money which can be provided by an automotive dealership as a trade-in or purchase value for a used vehicle—since most dealerships would recondition used vehicles to at least a particular standard before they would make them available for resale. The reconditioning costs of vehicles could include everything from the cost of washing or detailing the exterior or interior of the vehicle, fixing paint chips, replacing tires, windows or other parts. There is typically a defined standard dealerships would use to recondition a vehicle to—for most dealerships the standard of reconditioning would be similar in terms of reconditioning of vehicle to a general level of salability and road worthiness.

In many historical circumstances, the reconditioning cost for a vehicle would be estimated by having a dealership employee physically review the vehicle and identify items requiring attention or replacement. Often one of the key parameters of the vehicle which would be used by human estimators and past circumstances to get a ballpark idea of reconditioning cost would be the mileage of the vehicle coupled with its type or model etc. It is intended and desired in the present invention to come up with a method of estimating with a high degree of accuracy a net valuation which could be provided for a vehicle within a particular time period based upon the gross market value and the anticipated reconditioning cost of the target vehicle to a defined standard, without the need for personal inspection based upon the capture of one or more objective parameters in relation to the vehicle.

The reconditioning cost function is at the core of the present invention. The reconditioning cost function is effectively a mathematical function, model or formula which will be established by software operable on the server for use to determine the estimated reconditioning cost of a particular target vehicle. Mathematical functions which could be applied to a parameter set to yield a result, which could be used, might comprise one or more of the following types of mathematical functions:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

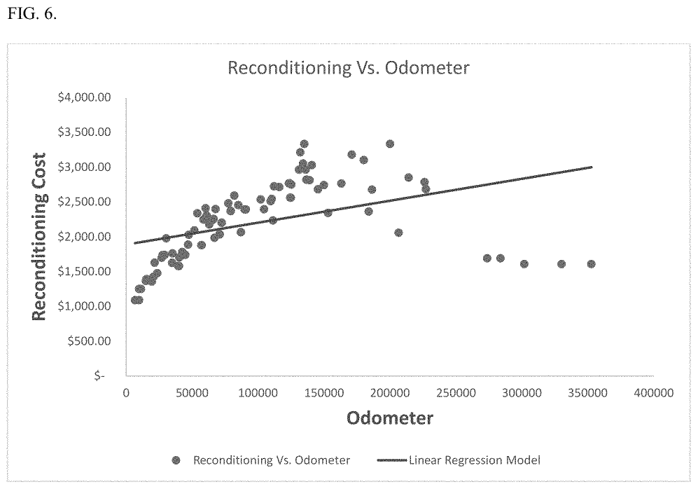

For instance, in the simplest form a linear regression model creates linear correlation between the reconditioning costs to the odometer reading of the vehicle, where the Y axis represents the reconditioning costs and the x-axis represents the corresponding odometer reading. The reconditioning cost function or model in this case would be a line, so that the sum of the square of the distances of each and every data point, represented by the odometer as x-axis and the reconditioning cost is the Y-axis is the minimum. FIG. 6 is a chart that demonstrates such a sample of a reconditioning cost function.

Cost Modifiers:

Local cost modifiers could be applied to modify the estimated reconditioning cost of the target vehicle. The cost modifiers could be mathematically or formulaically applied modifiers to the estimated reconditioning cost rendered by the reconditioning cost function. For example if it was desired by a particular subscribing vehicle acquisition outlet to modify the costs rendered by a reconditioning cost function by fixed percentage to accommodate some difference in their approach to resale, reconditioning or the like, or any number of other different types of cost modifiers could be contemplated for application. The types of cost modifiers which could be used could be selected non-exclusively from the list of user specific cost modifiers, geographic cost modifiers, subtotal labour costs, subtotal parts cost, estimated market value of the vehicle before reconditioning was started, accident and repair history modifiers, and average labour cost at the time or location of reconditioning to be conducted. The cost modifiers which could be applied it is contemplated would specifically be useful for slight distributor specific formulaic adjustments to rendered reconditioning cost estimates which would incorporate for example local labour rates, geographic adjustments or the like.

General System Overview:

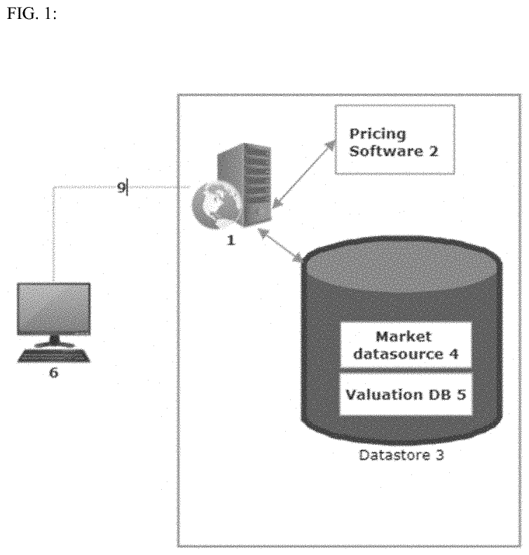

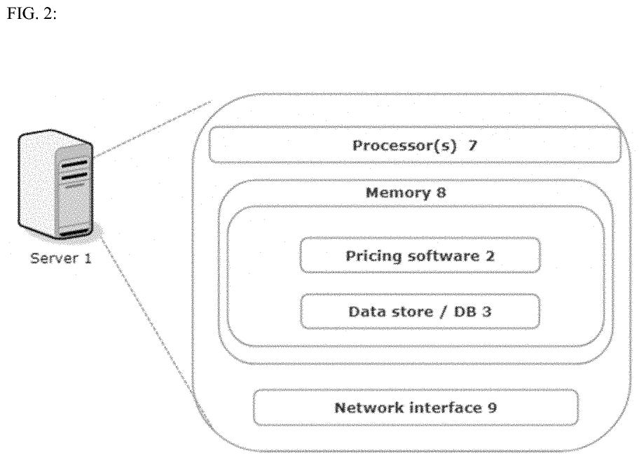

FIG. 1 and FIG. 2 demonstrate a system and server 1 which could be used in the execution of the method of the invention. The server 1, sample embodiment of which is shown in FIGS. 1 and 2, might consist of one or more servers 1—a single server or a server farm approach. Server 1 would comprise one or more processors 7 and memory 8. The memory 8 might include various processor instructions for the method of the present invention or otherwise operating the server 1. Processor instructions corresponding to the pricing software component 2 are shown stored within the memory 8 in this Figure. The server 1 can be configured by machine-readable instructions which might include one or more instruction components. The instruction components might include one or more of server firmware or operating systems, the pricing software component 2 and/or other instruction components.

The memory 8 might comprise non-transitory storage media that electronically stored information. Electronic storage media memory 8 might include one or both of system storage provided integrally with the server 1 and/or removal or connectable storage removably connected to the server 1 via for example a port or a drive. Memory 8 might also include one or more optically readable storage media, magnetically readable storage units, electric charge based storage media, solid-state storage media or other electronically readable storage media. The memory 8 may include one or more virtual storage resources i.e. cloud storage, VPN or the like and the memory 8 may store software algorithms, and information determined by processors 7, information received from service, or otherwise to function as outlined herein.

The processor 7 may be configured to provide information processing capabilities in the server 1. The processor 7 might include one or more of a digital processor, an analog processor, a digital circuit design and process information or analog circuit designs to process information, state machine and/or other mechanisms for electronically processing information. Although the processor 7 is shown as a single entity, this is for illustrative purposes only—in some implementations the processor 7 might include a plurality of processing units physically within the same device or might also represent processing functionality of a plurality of devices operating in coordination.

In many embodiments, the server 1 is contemplated to be a Web server which might also include a network interface 9, whereby client devices could communicate therewith. A client device 6 is also shown in FIG. 1—this could be the device which is used by a user to enter vehicle parameter data and respect of a target vehicle, in initiation of evaluation session in accordance with the remainder of the present invention, or alternatively could also receive the display of a completed valuation calculation at the tail end of the method. Various types of client devices 6 could be used, some having human interface such as a monitor or screen and others as outlined elsewhere being servers or local computer systems of dealerships or businesses which could interface on a machine level with the server 1 of the present invention.

The server 1 would also be operatively connected to a data store 3 besides the general operating system instructions. The data store 3 would potentially host the valuation database 5 as well as in certain embodiments a market data source 4 containing gross valuations for varying combinations of parameters and target vehicles. In other embodiments as described elsewhere herein, the market data source 4 rather than a locally hosted dataset could be another external system accessed via the network interface 9 of the server 1 and both such approaches are contemplated within the scope of the present invention.

The primary software component operable on the server 1 for the purpose of the conduct of the present embodiment of the method of the present invention is a pricing software component 2. The pricing software component, as will be understood to those skilled in the art of computer programming, would comprise processor instructions executable upon the processors 6 of the server 1 for the purpose of executing the steps of the method of the present invention.

The pricing software component 2 would contain the necessary processor instructions and mathematical modeling components as required to allow for the calculation and establishment of a net valuation of a target vehicle in accordance with the method outlined herein. Mathematical modeling functionality and computer software will be understood to those skilled in the art, and a mathematical modeling engine could be built into the software 2 of the present invention or separate mathematical modeling components could be connected in an operable way with the remainder of the pricing software component 2, and both such approaches are contemplated within the scope of the present invention.

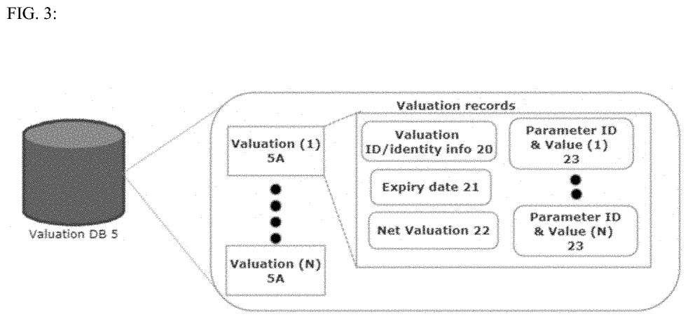

FIG. 3 demonstrates one schematic of a database design for the database 5 of the present invention in accordance with the remainder of the invention outlined herein. Referring to that Figure there is shown a database 5 comprised of a plurality of valuation records 5A, each of which corresponds to the calculation of a net valuation for a target vehicle in accordance with the remainder of the present invention. The database 5 or other accompanying data repository might also include the storage of additional data required for execution of varying embodiments of the general methodology of the present invention but it will be understood as outlined herein that this type of a general data structure with modifications as understood to those skilled in the art will form the basis and core of the invention.

Each valuation record 5A would correspond to a valuation calculation made in accordance with the remainder of the method of the present invention to calculate a guaranteed net valuation for a target vehicle for a trade-in or purchase transaction with a subscribing vehicle acquisition outlet. One example of the potential record configuration for a valuation record 5A is shown in FIG. 3. Firstly there is shown a valuation identifier or identity information 20 of the particular valuation of the target vehicle. This will be understood to those skilled in the art of database design to be likely a unique record identifier but could also be of vehicle serial number or identifying information of the target vehicle itself to combine two purposes for that data token in one field. In addition to the record identifier 20, the expiry date 21 and the net valuation 22 are shown as would be stored in the record 5A. The expiry date 21 would be the date before which the particular net valuation 22 for the target vehicle would be honored by a subscribing vehicle acquisition outlet. The net valuation 22 itself would be the calculated net valuation of the vehicle, representing the gross valuation of the vehicle less the anticipated reconditioning cost, which would be provided by the subscribing vehicle acquisition outlet in redemption or sale of the vehicle in a purchase or trade-in transaction. Also shown demonstratively is a plurality of parameter values 23—the valuation record 5A would it is anticipated in most embodiments store for record-keeping or other purposes the particular vehicle parameter values and the contents of the captured parameter set with respect to the target vehicle in question, upon which the net valuation 22 was based on calculated. It will be understood that additional fields and information might also be stored in a valuation record 5A to extend the functionality of the method of the present invention, including perhaps contact coordinates for the owner of the vehicle or the user initiating the valuation transaction in question or any number of other different types of additional parameters, identifying information or other values which would be useful to provide value-added functionality in accordance with the general underlying method outlined herein.

The particular table structure or data format of the valuation database 5 in accordance with the requirements and method of the present invention could take many different specific approaches and any different types of a data structure or format which still allows the software of the present invention to achieve the required steps of the method will be understood to be within the scope of the present invention.

Method Overview—Generating a Net Valuation:

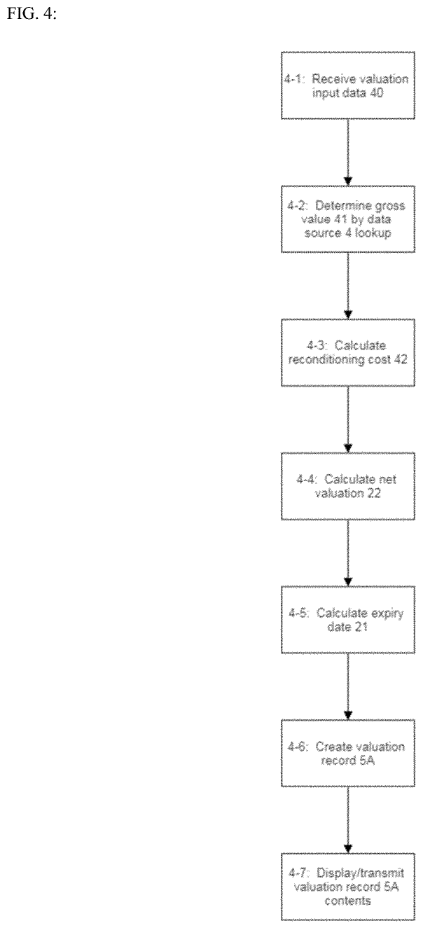

Turning to FIG. 4 there is shown a flow chart identifying the general steps of a method of establishing a net valuation in accordance with the method of the present invention for a target vehicle. The server 1 and pricing software component 2, in communication with the valuation database 5, would be used in the execution of this method.

Shown at step 4-1, following the initiation of a valuation session in respect of at least one target vehicle, the server 1 would receive from a client device 6 via the network interface 9 valuation input data 40 correspond to at least one target vehicle in respect of which it was desired to calculate a net valuation in accordance with the method of the present invention. As outlined elsewhere herein, the valuation input data 40 would comprise identifying information of the vehicle in question, along with a captured parameter set, representing parameter values of at least one vehicle parameter of the target vehicle. Upon receipt of a transmission of such valuation input data 40 the server 1 and related software components thereon could parse the transmission into the requisite information to conduct further processing steps of the method.

Shown at Step 4-2, the pricing software component 2 would determine the gross value 41 of the target vehicle by conducting a data source lookup on the market data source 4 which could either be externally connected or an internally hosted dataset. The gross value 41 would be selected based upon the values in the captured parameter set. The gross value 41 is the gross trade-in or sale value of the used target vehicle, once reconditioned or standardized to a particular industry standard.

Following the calculation of the gross value 41 of the target vehicle, in step 4-3 the pricing software component 2 would calculate the estimated reconditioning cost 42 of the target vehicle by applying a mathematical reconditioning cost estimating function. Various types of mathematical reconditioning cost functions are outlined herein, based either on a simple lookup in a data table based upon the particular parameters stored within the captured parameter set, or in some cases a model based on historical reconditioning costs might also be used. In any event, the reconditioning cost 42 would be estimated for the vehicle.

In the next step 4-4, the pricing software component 2 would calculate the net valuation 22 of the target vehicle by subtracting the estimated reconditioning cost 42 from the gross vehicle value 41. The net valuation 22 is the amount which a subscribing vehicle acquisition outlet would provide to a vendor on the trade in our purchase of the target vehicle, effectively representing the gross trade-in value or used sale value of the vehicle less the estimated reconditioning cost.

The pricing software component would also then calculate an expiry date 21 in terms of the validity of the net valuation 22. Effectively the underlying premise of the present invention is that the system would permit for the unattended issuance of used target vehicle valuations which could be binding upon subscribing vehicle acquisition outlets for a fixed period of time following their calculation or issuance. So for example, it may be determined that the valuations generated by the system and method of the present invention should be honored for two weeks or for a month thereafter, and the expiry date 21 could be calculated on this basis. The expiry date 21 could also be calculated on the basis of contents of the captured parameter set, or other vehicle identifying information, or even information pertaining to specific subscribing vehicle acquisition outlets i.e. different outlets taking trade-ins might be prepared to honor valuations for longer or shorter periods of time, and the calculation of the expiry date 21 or dates could be adjusted accordingly.

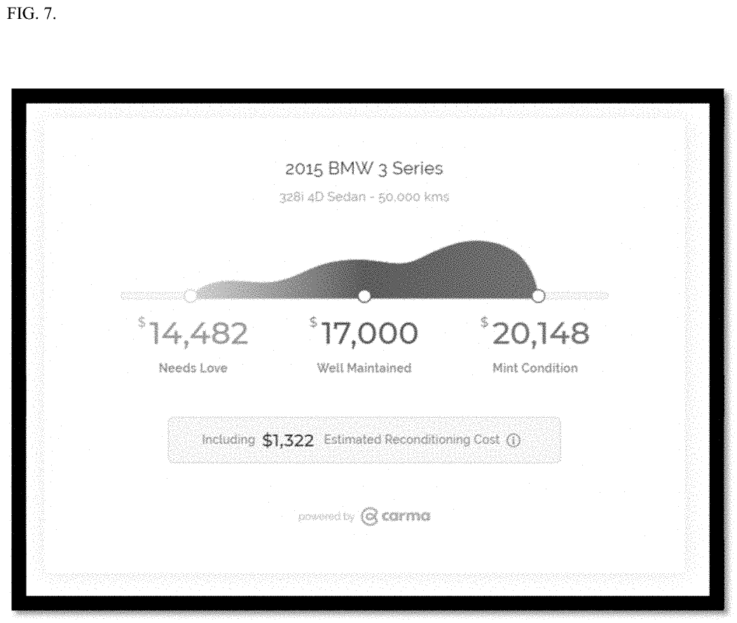

Once the net valuation 22 and the expiry date 21 of the net valuation have been calculated, the pricing software component 2 could execute the creation of a valuation record 5A within the valuation database 5. This would store the results of the net valuation calculation of the present invention so that it could be later looked up by a subscribing vehicle acquisition outlet to verify and honor that valuation. The final step of the method is the display or transmission of the contents of the calculated and created valuation record 5A to a user device, be that a device with a human interface on which the results and contents of that record would be displayed for human reading or interaction, or in other cases where the server 1 of the present invention was receiving and communicating with a server or computer of a commercial outlet or even a subscribing vehicle acquisition outlet who is potentially interested in conducting all valuations etc., the server acting as the client device could receive readable machine data corresponding to the results stored within the created valuation record as well. Where a physical display on a human interface of the client device was used to display the contents of an executed valuation transaction in accordance with the method of the present invention, the following is a sample display which might be displayed to a user where the calculated net valuation 22 appears in a range, rather than as a single fixed number. As outlined elsewhere herein, either the gross market value 41 or the estimated reconditioning cost 42 might be calculated as ranges having lower and upper values which could be combined to render a net valuation 22 of arrange versus a fixed number. This would still be within the intended scope of the present invention, since the system will still provide a fixed range of a trade-in or purchase value, defining the value which would be provided by the dealership in respect of trade-in or purchase of a used vehicle. Even the provision of a binding range rather than a fixed amount for the net valuation 22 would be a significant commercial advantage for subscribing vehicle acquisition outlets participating in electronic method as outlined, since it would give them the ability to solicit trade-ins or purchases of used target vehicles on the basis of educated valuations conducted without inspection of the vehicle, which could still be subjected to a quick in person inspection on trade-in or sale of the vehicle to determine where within the fixed range the value would sit. FIG. 7 is an exemplary graphical user interface and is explicitly contemplated again to not depart from the intended scope and intent of the invention.

The transmission or display of the contents of the valuation record 5A might also include information confirming which subscribing vehicle acquisition outlets are prepared to honor the valuation although that might be otherwise used. It is specifically contemplated that the software method of the present invention could be embedded within website business methods operated by automotive dealerships seeking to sell new or used vehicles on the basis of trade in or purchase of used vehicle inventory. As outlined above, the method of the present invention could be offered on the basis of a single subscribing vehicle acquisition outlet i.e. a single company could offer the software of the present invention through a single website etc., or alternatively in a service Bureau approach, the functionality of the method outlined herein could be offered on a white label basis through multiple subscribing vehicle acquisition outlet websites etc. The reach and configurability of the system and method of the present invention for use through these different channels will be understood to those skilled in the art of client/server web application development and all such approaches are contemplated within the scope of the present invention.

Effectively what is then contemplated is that when the owner of a particular target vehicle in respect of which a valuation has been conducted in a valuation record 5A created could attend to a subscribing vehicle acquisition outlet of the service of the method who were obliged to honor the net valuation 22 of the target vehicle within the expiry date timeframe, and the subscribing vehicle acquisition outlet upon verification of the valuation record in question by a web lookup or other software interface would honor the net valuation 22 so long as the expiry date 21 in respect of that net valuation 22 had not expired. It is explicitly contemplated that the net valuation 22 might be used at a subscribing vehicle acquisition outlet to either sell used vehicle to the outlet, or to trade it in on another purchase transaction. Separate values for the net valuation 22 could be stored for a sale or trade-in basis, dependent upon if some subscribing vehicle acquisition outlets would calculate different values. The system and method and mathematical model could be adjusted to accommodate such flexibility.

Valuation sessions in accordance with the method of the present invention may calculate the net valuation 22 for more than one target vehicle at a time, if valuation input data 40 pertaining to more than one target vehicle is contained within a particular transmission to the server at the time that a valuation session is initiated.

Method Overview—Sale or Trade-In Transaction:

A further embodiment of the method of the present invention would directly incorporate the lookup of the net valuation 22 pertaining to a target vehicle and the completion of a commercial transaction based on the net valuation 22 amount. A net valuation 22 for the target vehicle in question would be looked up on the valuation database 5 based upon identifying information of the target vehicle which was received initially in the valuation input data 40 received one the particular target vehicle was valued in accordance with the remainder of the method, and which was stored in the corresponding valuation record 5A for the purpose of facilitating such a lookup. A record identifier or the like could also be provided to the user at the time the valuation was conducted and that could also be used to conduct a lookup.

Upon the conduct of a lookup of a corresponding valuation record 5A on the valuation database 5, where the net valuation 22 is a fixed amount and the expiry date has not yet expired, the subscribing vehicle acquisition outlet to whom the target vehicle was to be tendered would complete a commercial transaction for sale or trade-in of the target vehicle on the basis of the net valuation 22 which had earlier been calculated in accordance with the remainder of the method. If the net valuation 22 is a range, rather than a fixed number, which was subject to a brief physical inspection of the target vehicle at the time of execution of a transaction, again so long as the expiry date had not yet expired such that the net valuation 22 was active, the subscribing vehicle acquisition outlet would conduct such a brief inspection and would fix the valuation of the target vehicle within the range of the net valuation 22 which was stored in the corresponding valuation record 5A and honor those upper and lower range amounts and limits in the valuation of the vehicle.

As indicated and outlined elsewhere above, the actual valuation of the vehicle when conducted could be modified by the application of either subscribing vehicle acquisition outlet specific or market specific cost modifiers to the estimated reconditioning cost. Permitting for the adaptability or customization of the net valuation 22 on an individual subscribing vehicle acquisition outlet basis will be understood to be within the realm and intended scope of the present invention also. What is effectively desired is to provide a wide area network or Web-enabled method of providing binding valuations of target vehicles which would be redeemable at subscribing automotive dealerships or subscribing vehicle acquisition outlets capable of accepting those target vehicles on trade-ins or purchases, and that subject to a quick verification of the captured parameter set which was used to generate the net valuation 22, or in the case of the valuation including a range requiring a quick physical inspection at the time of the transaction to trade-in or purchase the vehicle, the system would issue a time-limited binding net valuation 22 which could be redeemed at a subscribing vehicle acquisition outlet in a trade-in or purchase transaction. Removal of the need for the conduct of a physical inspection of a vehicle to issue a binding net valuation 22 is going to open up myriad new opportunities for companies working in the area of used vehicle acquisition to advertise and sell their businesses and to acquire used vehicle inventory. The utility of the method of the present invention, which basically depends upon the creation of an agreeable and binding mathematical reconditioning cost generating function, will be understood to those in the industry. So long as a company is prepared to accept the results of the mathematical reconditioning cost generating function subject to whatever type of localization or modifiers may be required or desired, they would be able to participate in a more streamlined online prospecting method in which effectively owners of target vehicles could on a self-service basis value their own vehicle and complete another step in the process of structuring a trade-in or purchase transaction for their used target vehicle. Individual subscribing vehicle acquisition outlets or groups of subscribing vehicle acquisition outlets might also stipulate certain combinations of vehicle parameters which needed to be included in captured parameter sets to validate net valuations 22 conducted by the method of the present invention for their use and purposes. Again this flexibility will be understood to be within the scope of the invention as outlined.

It will be understood based on the language outlined herein that many different types of mathematical functions which could be applied to captured parameter sets are contemplated for use in accordance with the index records and the remainder of the software and the method of the present invention, to allow for parameter based estimation of the reconditioning cost or trade-in value of target vehicles.

The method of the present invention will also specifically comprise a system and method explicitly facilitating the purchase or trade-in transactions of target vehicles based upon net valuations calculated in accordance with the remainder of the method. In certain embodiments of the method, as outlined in the claims, in addition to creating valuation records and evaluation database as outlined, the server 1 would explicitly facilitate the receipt of vehicle identifying information in respect of a particular target vehicle based upon which a database lookup on the evaluation database 5 can take place to identify if there were any valid non-expired valuations for the target vehicle which could be redeemed at a relevant subscribing vehicle acquisition outlet. If a valid non-expired valuation exists, which applies to the subscribing vehicle acquisition outlet in question, the subscribing vehicle acquisition outlet would be obliged by virtue of the business arrangement between the owner of the target vehicle and through operation of the system and method of the present invention to honor that valuation 22 in the facilitation of a buyback or trade-in transaction for the target vehicle.

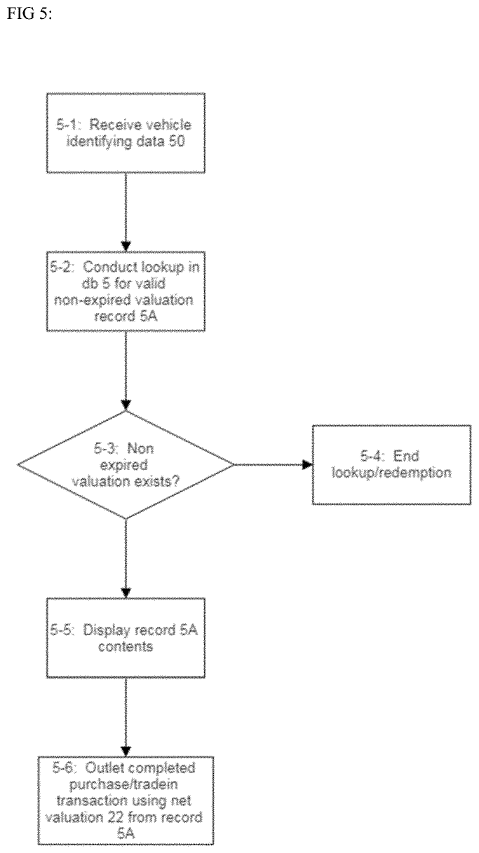

FIG. 5 demonstrates the redemption substeps of the method of the present invention. Upon receipt of vehicle identifying data 50 at the server 1 from a client device (step 5-1), the server 1 and the pricing software component 2 would conduct a database lookup on the valuation database 5 to ascertain whether any non-expired valuation record exists—ie. are there any extant valuation records 5A within the valuation database 5 for which the expiry date has not yet elapsed? If not, the redemption process would be ended, shown at step 5-4. If there was an existing and non-expired valuation record 5A on the valuation database 5 pertained or applied to the subscribing vehicle acquisition outlet in question, the subscribing vehicle acquisition outlet would receive a display of the record contents 5 and would be obliged to complete a purchase or trade-in transaction based on the net valuation 22 stored within the located valid and non-expired valuation record 5A.

Although the present technology has been described for illustration based on what is considered the most practical and preferred implementations, it is to be understood that such detail is solely for that purpose and that the technology is not limited to the disclosed implementations, but, on the contrary, should cover modifications and equivalent arrangements within the spirit and scope of the appended claims. For example, it is to be understood that the present technology contemplates that, to the extent possible, one or more features of any implementation can be combined with one or more features of any other implementation.

In addition, it will be apparent to those of skill in the art that by routine modification the present invention can be optimized for a wide range of conditions and application. It will also be obvious to those of skill in the art there are various ways and designs with which to produce the apparatus and methods of the present invention. The illustrated embodiments are therefore not intended to limit the invention, but to provide examples of the apparatus and method to enable those of skill in the art to appreciate the inventive concept.

We claim:

1. A computer-implemented method of issuing a time-limited net valuation guarantee for a target vehicle, said method comprising:
a. providing a server comprising:
i. a processor and memory;
ii. a network interface for communication with client devices;
iii. a pricing software component for carrying out the steps of the method;
iv. a valuation database comprising a plurality of valuation records each corresponding to a net valuation of a target vehicle and including at least identifying information of the target vehicle, parameter values of at least one vehicle parameter of the target vehicle, the calculated net valuation, and an expiry date for the net valuation; and
v. an operative connection to a market data source comprising a plurality of market records each comprising parameter values of at least one vehicle parameter of a vehicle and a gross value for the vehicle;
b. in a valuation session in respect of at least one target vehicle:
i. receiving valuation input data at the server from a client device in network communication with the server in respect of each at least one target vehicle, said valuation input data corresponding to:
1. identifying information of the vehicle; and
2. a captured parameter set, being parameter values of at least one vehicle parameter of the target vehicle;
ii. on receipt of said valuation input data at the server for a target vehicle, being the subject vehicle, using the pricing software component on the server to:
1. establish the net valuation of the subject vehicle by:
a. determining a gross value from the market data source based on the captured parameter set for the subject vehicle;
b. applying a mathematical reconditioning cost function acceptable to at least one subscribing vehicle acquisition outlet to the captured parameter set to yield the estimated reconditioning cost of the subject vehicle; and
c. calculating the net valuation of the subject vehicle by subtracting the estimated reconditioning cost from the gross value of the target vehicle;
2. calculating an expiry date for the net valuation;
3. creating a valuation record within the valuation database containing the identifying information of the subject vehicle, the corresponding captured parameter set contained within the valuation input data, the calculated net valuation, and the calculated expiry date; and
4. transmitting the details of the valuation record to a client device of a user;
wherein no physical inspection of a target vehicle is conducted by a subscribing vehicle acquisition outlet; and
wherein any of at least one subscribing vehicle acquisition outlets can conduct a redemption step comprising the conduct of a search of the valuation database through a user interface to the server to identify the details of a corresponding valuation record using identifying information of the target vehicle and, within the timeframe defined by the expiry date in that record, honour the calculated net valuation for the target vehicle stored within the valuation record.

2. The method of claim 1 wherein the subscribing vehicle acquisition outlet accepting the target vehicle will purchase the target vehicle from the owner thereof for the value of the calculated valuation stored within the valuation record.

3. The method of claim 1 wherein the subscribing vehicle acquisition outlet accepting the target vehicle will accept the target vehicle as a trade-in in a purchase transaction for another vehicle, and will provide a net valuation in the transaction equivalent to the calculated valuation stored within the valuation record.

4. The method of claim 1 wherein the client device in network communication with the server in the valuation session is a personal electronic device of a user being a related party of the vehicle being valued, and the user of that device enters the valuation input data at that device via a user interface.

5. The method of claim 4 wherein the client device of a user to which the details of a valuation record are transmitted is the personal electronic device of the related party of the vehicle being valued.

6. The method of claim 1 wherein the client device in network communication with the server in a valuation session, providing the valuation input data for at least one target vehicle, is a server of a subscribing vehicle acquisition outlet.

7. The method of claim 6 wherein the valuation input data for at least one target vehicle is assembled for transmission to the server from accessible data sources of the subscribing vehicle acquisition outlet.

8. The method of claim 6 wherein the client device of the user to which the details of a valuation record are transmitted is the server of the subscribing vehicle acquisition outlet having provided the valuation input data.

9. The method of claim 1 wherein the gross value determined from the market data source is a fixed value.

10. The method of claim 9 wherein the net valuation calculated is a fixed value.

11. The method of claim 1 wherein the gross value determined from the market data source is a range with an upper value and a lower value.

12. The method of claim 11 wherein the net valuation calculated is a range with an upper value and a lower value, calculated based on the upper value and lower value of the gross value.

13. The method of claim 12 wherein the calculated net valuation as transmitted to the user is stored and transmitted as a range of at least two values between the upper and lower values of the range, representing in-range net valuation values based upon the actual assessed trade-in condition of the vehicle.

14. The method of claim 1 further comprising transmitting the details of a valuation session and valuation record to the client device of the user for offline use and subsequent retrieval.

15. The method of claim 1 wherein the number of subscribing vehicle acquisition outlets is one.

16. The method of claim 1 wherein the number of subscribing vehicle acquisition outlets is more than one.

17. The method of claim 16 wherein not all of the subscribing vehicle acquisition outlets of the method are subscribing vehicle acquisition outlets for a particular valuation.

18. The method of claim 1 wherein the at least one vehicle parameter of a captured parameter set is selected from the group of:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN).

19. The method of claim 1 wherein the calculation of the reconditioning cost of the vehicle further comprises the application of at least one cost modifier to the estimated reconditioning cost.

20. The method of claim 19 wherein the cost modifiers are selected from the list of:
a. user-specific cost modifiers;
b. geographic cost modifiers;
c. sub-total labour cost;
d. sub-total parts cost;
e. estimated market value of the vehicle before reconditioning was started;
f. accident and repair history modifiers; and
g. average labour cost at the time or location of reconditioning to be conducted.

21. The method of claim 1 wherein the mathematical reconditioning cost function used by the pricing software component is a mathematical function based on historical reconditioning costs of similar vehicles, and applying the reconditioning cost function to the parameter values from the captured parameter set will yield the result of the reconditioning cost function being the estimated reconditioning cost of the target vehicle.

22. The method of claim 1 wherein the mathematical reconditioning cost function used by the pricing software component comprises a valuation database lookup of predetermined valuation amounts for vehicles of any combination of parameters and parameter values within the captured parameter set.

23. The method of claim 1 wherein the mathematical reconditioning cost function used by the pricing software component is a mathematical function of a type selected from the list of:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

24. The method of claim 1 wherein the server is a web server and the client devices interact with the server via a browser interface.

25. The method of claim 1 further comprising a vehicle acquisition outlet notification step where any subscribing vehicle acquisition outlets to whom a new valuation record applies will be notified of the creation of said new valuation record and its details.

26. A computer-implemented method of facilitating a purchase or trade-in transaction for a target vehicle based on a time-limited net valuation guarantee for a target vehicle, said method using a server comprising:
iii. a processor and memory;
iv. a network interface for communication with client devices;
v. a pricing software component for carrying out the steps of the method;
vi. a valuation database comprising a plurality of valuation records each corresponding to a net valuation of a target vehicle and including at least identifying information of the target vehicle, parameter values of at least one vehicle parameter of the target vehicle, the calculated net valuation, and an expiry date for the net valuation; and
vii an operative connection to a market data source comprising a plurality of market records each comprising parameter values of at least one vehicle parameter of a vehicle and a gross value for the vehicle;
said method comprising:
a. upon receipt of a request at the server from a client device of a user in network communication with the server to initiate a valuation session in respect of at least one target vehicle, calculating a time-limited net valuation guarantee for the at least one target vehicle without any physical inspection by a subscribing vehicle acquisition outlet by:
i. receiving valuation input data at the server from the client device in respect of each at least one target vehicle, said valuation input data corresponding to:
1. identifying information of the vehicle; and
2. a captured parameter set, being parameter values of at least one vehicle parameter of the target vehicle;
ii. using the pricing software component on the server to establish the net valuation of the subject vehicle by:
1. determining a gross value from the market data source based on the captured parameter set for the subject vehicle;
2. applying a mathematical reconditioning cost function acceptable to at least one subscribing vehicle acquisition outlet to the captured parameter set to yield the estimated reconditioning cost of the subject vehicle; and
3. calculating the net valuation of the subject vehicle by subtracting the estimated reconditioning cost from the gross value of the target vehicle;
4. calculating an expiry date for the net valuation;
5. creating a valuation record within the valuation database containing the identifying information of the subject vehicle, the corresponding captured parameter set contained within the valuation input data, the calculated net valuation, and the calculated expiry date; and
6. transmitting the details of the valuation record to the client device for display;
b. upon receipt of a request at the server from a client device of a subscribing vehicle acquisition outlet in network communication with the server to initiate a redemption transaction in respect of a target vehicle, honouring a time-limited net valuation guarantee issued by the method by:
i. receiving vehicle identifying data at the server from the client device in respect of the target vehicle;
ii. conducting a lookup in the valuation database for a valuation record corresponding to the target vehicle, using the vehicle identifying data, and in respect of which the net valuation represented by the particular valuation record has not yet expired by virtue of the expiry date stored within the valuation record not having expired;
iii. if a valid non-expired valuation record is located in the lookup query, displaying the valuation record contents of the valid non-expired valuation record to the client device of the subscribing vehicle acquisition outlet;
wherein the subscribing vehicle acquisition outlet will apply the net valuation stored within the valid non-expired valuation record to the purchase or trade-in business transaction with the owner of the target vehicle to acquire the target vehicle in a purchase or trade-in transaction.

27. The method of claim 26 wherein the gross value determined from the market data source is a range with an upper value and a lower value.

28. The method of claim 26 wherein the net valuation stored within the valid non-expired valuation record is a range with an upper value and a lower value.

29. The method of claim 16 wherein not all of the subscribing vehicle acquisition outlets of the method are subscribing vehicle acquisition outlets for a particular valuation.

30. The method of claim 1 wherein the at least one vehicle parameter of a captured parameter set is selected from the group of:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN).

31. The method of claim 1 wherein the calculation of the reconditioning cost of the vehicle further comprises the application of at least one cost modifier to the estimated reconditioning cost.

32. The method of claim 19 wherein the cost modifiers are selected from the list of:
a. user-specific cost modifiers;
b. geographic cost modifiers;
c. sub-total labour cost;
d. sub-total parts cost;
e. estimated market value of the vehicle before reconditioning was started;
f. accident and repair history modifiers; and
g. average labour cost at the time or location of reconditioning to be conducted.

33. The method of claim 1 wherein the mathematical reconditioning cost function used by the pricing software component is a mathematical function based on historical reconditioning costs of similar vehicles, and applying the reconditioning cost function to the parameter values from the captured parameter set will yield the result of the reconditioning cost function being the estimated reconditioning cost of the target vehicle.

34. The method of claim 1 wherein the mathematical reconditioning cost function used by the pricing software component comprises a valuation database lookup of predetermined valuation amounts for vehicles of any combination of parameters and parameter values within the captured parameter set.
